(19) United States
(12) Patent Application Publication
(10) Pub. No.: US 2022/0285970 A1
(43) Pub. Date: Sep. 8, 2022

(54) MANAGING POWER BETWEEN WEARABLE DEVICES

(71) Applicant: RHiot, Inc., Vancouver, WA (US)

(72) Inventor: Jonathan Lovegrove, Yacolt, WA (US)

(21) Appl. No.: 17/193,825

(22) Filed: Mar. 5, 2021

(51) Int. Cl. H02J 7/34; H02J 7/00; H02J 7/02; H02J 50/90

(52) U.S. Cl. CPC H02J 7/342; H02J 7/0047; H02J 7/02; H02J 7/0071; H02J 50/90

(57) ABSTRACT

Examples are disclosed that relate to wearable devices, systems, and methods for managing power between wearable devices. One example provides a first wearable device including a first power storage device, a processor, and a memory storing instructions executable by the processor. The instructions are executable to determine charge states of the first power storage device and a second power storage device coupled to a second wearable device. Power usage priorities are assigned for the first wearable device and the second wearable device, and target charge states are determined for the first power storage device and the second power storage device. Based on the charge states, the power usage priorities, and the target charge states, a wireless power transmission harness is used to wirelessly transfer power between the first power storage device and the second power storage device.

### BACKGROUND

Wearable devices are used in a wide variety of settings, such as in manufacturing, military, emergency response, resource extraction, and athletics organizations. An individual working in these settings may use two or more wearable devices. These devices may include power storage devices, which may be drained at different rates in different devices, in different environments, or in different usage scenarios. However, it can be challenging to transfer power from one wearable device to another.

### SUMMARY

According to one aspect of the present disclosure, a first wearable device is provided, including a first power storage device, a processor, and a memory storing instructions executable by the processor. The instructions are executable to determine charge states of the first power storage device and a second power storage device coupled to a second wearable device. Power usage priorities are assigned for the first wearable device and the second wearable device, and target charge states are determined for the first power storage device and the second power storage device. Based on the charge states, the power usage priorities, and the target charge states, the instructions are further executable to use a wireless power transmission harness that is removably coupled to the first wearable device and the second wearable device to wirelessly transfer power between the first power storage device and the second power storage device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a system including a first wearable device, a second wearable device, and a wireless power transmission harness that is removably coupled to the first wearable device and the second wearable device, according to one example embodiment.

FIG. 2 shows an example of a first wearable device, a second wearable device, and additional wearable devices, according to one example embodiment.

FIG. 3 shows an example of a charging decision model according to one example embodiment.

FIG. 4 shows a flowchart of an example method for managing power between wearable devices according to one example embodiment.

FIG. 5 shows a schematic diagram of an example computing system, according to one example embodiment.

### DETAILED DESCRIPTION

As introduced above, wearable devices are used in a wide variety of settings, such as in manufacturing, military, emergency response, resource extraction, and athletics organizations. An individual working in these settings may use two or more wearable devices. For example, a diver may wear multiple biometric and life support devices, and an athlete may wear one or more accelerometers, biometric devices, and load sensors.

These devices may include power storage devices, which may be drained at different rates in different devices, in different environments, or in different usage scenarios. For example, a soldier operating at night may quickly drain power from a battery coupled to the soldier's night vision goggles. A battery coupled to the soldier's radio may be drained at a slower rate. However, it can be challenging to transfer power from one wearable device to another.

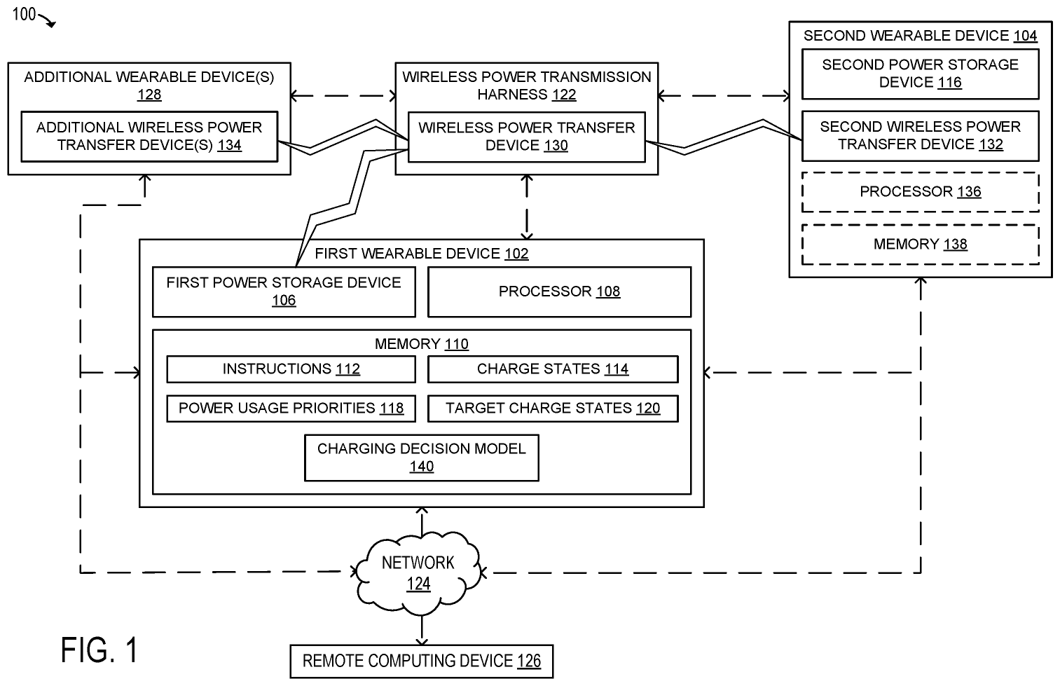

To address the above shortcomings of some systems of wearable devices, a system 100 is provided including a first wearable device 102 and a second wearable device 104, as schematically shown in the example of FIG. 1. The first wearable device 102 includes a first power storage device 106, a processor 108, and memory 110 which may include volatile memory and non-volatile memory. The memory 110 stores instructions 112 executable by the processor 108.

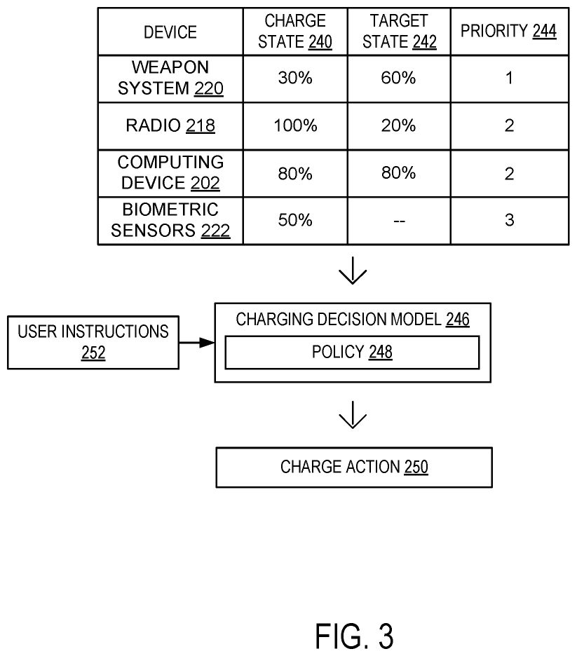

Briefly, the instructions 112 are executable to determine charge states 114 of the first power storage device 106 and a second power storage device 116 coupled to the second wearable device 104. The instructions 112 are further executable to assign power usage priorities 118 for the first wearable device 102 and the second wearable device 104. In addition, the instructions are executable to determine target charge states 120 for the first power storage device 106 and the second power storage device 116. Based on the charge states 114, the power usage priorities 118, and the target charge states 120, a wireless power transmission harness 122 that is removably coupled to the first wearable device 102 and the second wearable device 104 is used to wirelessly transfer power between the first power storage device 106 and the second power storage device 116. For example, and as described in more detail below with reference to FIG. 3, the first wearable device 102 may implement a charging decision model 140 to determine how to allocate power between the first wearable device 102 and the second wearable device 104.

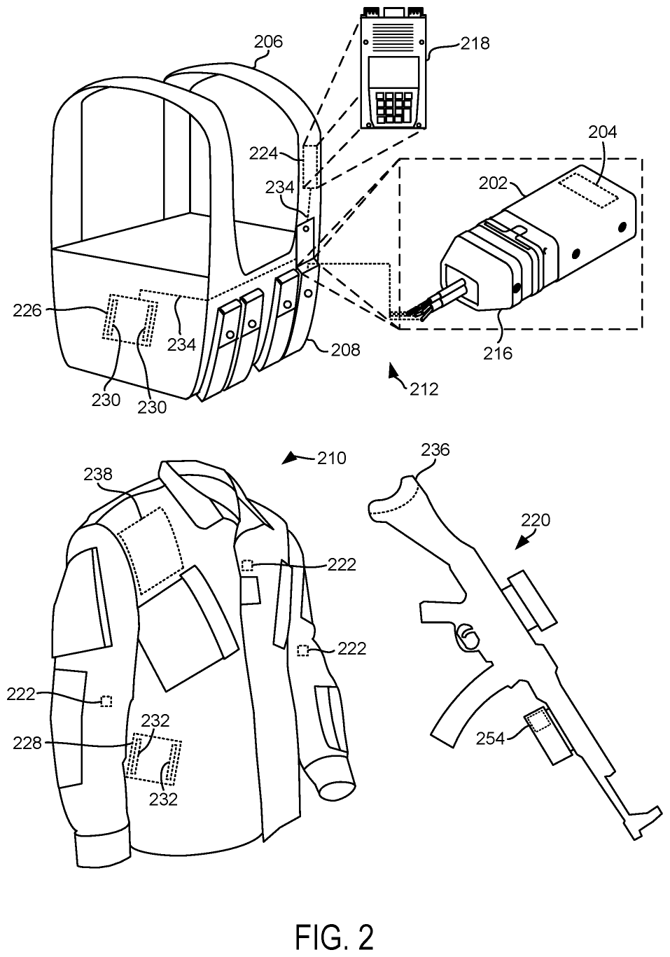

Further, and as described in more detail below, the first wearable device 102 and the second wearable device 104 may also be removably coupled to one or more additional wearable devices 128 via the wireless power transmission harness 122. The wireless power transmission harness 122 may be electrically coupled to the first wearable device 102, the second wearable device 104, and/or the one or more additional wearable device(s) by a wired or wireless connection. As described in more detail below with reference to FIG. 2, the first wearable device 102 may be coupled to the wireless power transmission harness 122 via a hardwired connection, while the second wearable device 104 and/or the one or more additional wearable devices 128 may be wirelessly coupled to the wireless power transmission harness 122. For example, the wireless power transmission harness 122 includes a wireless power transfer device 130 configured to electrically couple with a second wireless power transfer device 132 of the second wearable device 104 and with one or more additional wireless power transfer device(s) 134 of the one or more additional wearable device(s) 128.

In some examples, the system 100 includes one or more data couplings between the first wearable device 102, the second wearable device 104, and/or the one or more additional wearable device(s) 128. The second wearable device 104 and/or the one or more additional wearable device(s) 128 may communicate directly with the first wearable device 102, or indirectly with the first wearable device 102. For example, the second wearable device 104 and/or the one or more additional wearable device(s) 128 may be indirectly coupled with the first wearable device 102 via the wireless power transmission harness 122 or a network 124 (e.g., a local area network or a wide area network, such as the Internet).

It will also be appreciated that the second wearable device 104 may additionally or alternatively comprise a computing device having its own processor 136 and memory 138, which may be configured to enact at least a portion of the methods disclosed herein. In some examples, the first wearable device 102 and/or the second wearable device 104 may be referred to as an edge computing device. An edge computing device is a computing device having a position on a network topology between a local network (e.g., a network formed by the data couplings between the first wearable device 102, the second wearable device 104, the wireless power transmission harness 122, and/or the one or more additional wearable device(s) 128) and a wider area network (e.g., the Internet) to a remote computing device 126.

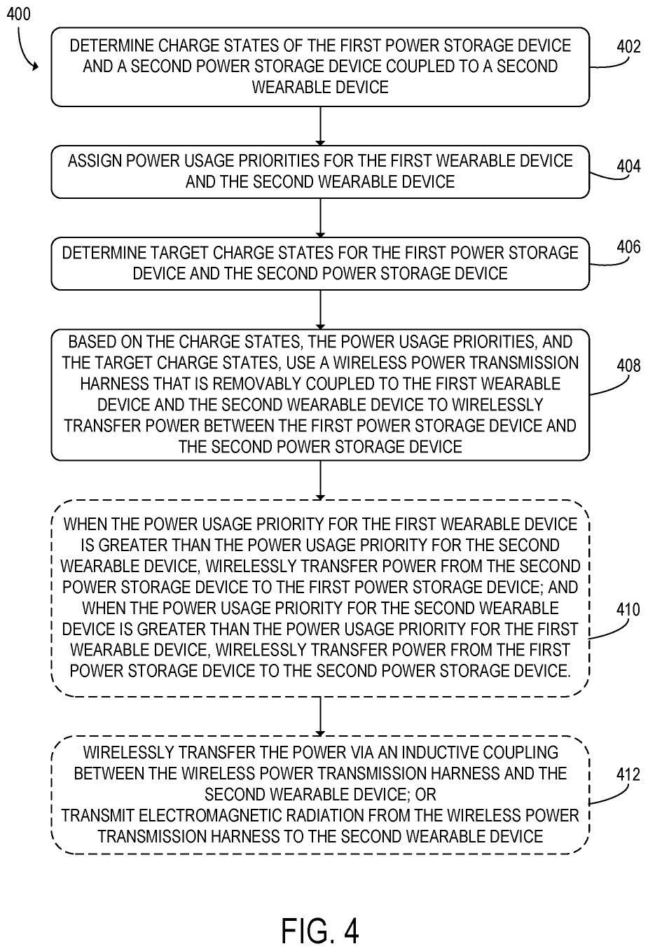

With reference now to FIG. 2, one example of a first wearable device is illustrated in the form of a computing device 202. The computing device 202 comprises a power storage device 204, such as a battery, a capacitor, or any other suitable power storage device. Additional aspects of the computing device 202 are described in more detail below with reference to FIG. 4.

In some examples, the computing device 202 is integrated with a garment, such as a fighting load carrier (FLC) 206. For example, the computing device 202 may be worn inside of a magazine pouch 208. In other examples, the computing device 202 may be coupled to the FLC 206 via Modular Lightweight Load-carrying Equipment (MOLLE), All-purpose Lightweight Individual Carrying Equipment (ALICE), or other suitable load-coupling systems. It will also be appreciated that the computing device 202 may be integrated with any other suitable garment or wearable platform, such as a uniform top 210, an armored vest, a rucksack, a wristband, a diving suit, a tool belt, etc.

The computing device 202 is removably coupled to wireless power transmission harness 212. By being “removably coupled”, the computing device 202 may be detached from the wireless power transmission harness 212. As shown in FIG. 2, the wireless power transmission harness 212 is integrated with the FLC 206. In other examples, the wireless power transmission harness may be integrated with any other suitable garment or wearable platform, such as the uniform top 210. In yet other examples, the wireless power transmission harness may comprise a separate system or device.

In some examples, the wireless power transmission harness 212 comprises a detachable electrical connector 216 configured to couple with the computing device 202. In this manner, the wireless power transmission harness may establish a hardwired connection with the computing device 202. It will also be appreciated that the wireless power transmission harness may be coupled to the computing device 202 in any other suitable manner.

The wireless power transmission harness 212 is also removably coupled to a second wearable device, and optionally to one or more additional wearable device(s). For example, the wireless power transmission harness may be coupled to a radio 218, a weapon system 220, biometric sensors 222, accelerometers, pressure/load sensors, an auxiliary battery pack, a navigation device, night vision goggles, a head-mounted display, or any other suitable devices.

The wireless power transmission harness 212 is electrically coupled to a second wearable device (e.g., the radio 218) via a wireless power transfer device. In some examples, the wireless power transfer device takes the form of an inductive coil configured to transmit and/or receive power via an inductive coupling between the wireless power transmission harness and the second wearable device. In other examples, the wireless power transfer device may comprise an electromagnetic transceiver configured to transmit power to the second wearable device or receive power from the second wearable device in the form of electromagnetic radiation.

For example, the wireless power transmission harness 212 of FIG. 2 comprises a first inductive charging pad 224. The first inductive charging pad 224 comprises an inductive coil and is configured to be coupled to a corresponding inductive coil (not shown) that is electrically coupled to the radio 218. In this manner, power may be transferred to or from the radio 218 via inductive coupling.

The wireless power transmission harness 212 further comprises a second inductive charging pad 226 configured to couple with a corresponding inductive charging pad 228 located in the uniform top 210. In some examples, the inductive charging pad 226 and the corresponding inductive charging pad 228 are aligned in a charging alignment when the FLC 206 is worn over the uniform top 210. In the charging alignment, an inductive coil within the inductive charging pad 226 and an inductive coil within the inductive charging pad 228 are aligned such that an inductive coupling is established between the inductive charging pads 226 and 228.

In some examples, the wireless power transmission harness may be magnetically coupled to a second wearable device, thereby aligning the wireless power transfer device in a charging alignment with a second wireless power transfer device. For example, the inductive charging pad 226 may comprise one or more magnets 230 and the inductive charging pad 228 may comprise one or more complementary magnets 232 having an opposite polarity to the one or more magnets 230. The magnets 230 and 232 are configured to mate when the wireless power transmission harness 212 is worn over the uniform top 210, thereby aligning the inductive charging pads 226 and 228. In addition, the magnets 230 and 232 may secure the inductive charging pads 226 and 228 such that the inductive charging pads do not become uncoupled during use.

As shown in FIG. 2, two or more wearable devices may be coupled to the wireless power transmission harness 212 at different locations. For example, the radio 218 is coupled to the wireless power transmission harness 212 via the inductive pad 224 and the uniform top 210 is inductively coupled to the wireless power transmission harness 212 via the inductive pad 226. The inductive pads 224 and 226 are both integrated into the FLC 206 at different locations than the computing device 202.

Accordingly, the wireless power transmission harness 212 comprises one or more lines 234 of a conductive material electrically coupling the computing device 202, the inductive pad 224, and the inductive pad 226. The one or more lines 234 of the conductive material may comprise a wire, a conductive yarn, a conductive ink, or any other suitable conductive material. In this manner, the wireless power transmission harness 212 is configured to electrically couple the computing device 202 and the radio 218.

Two or more wearable devices may additionally or alternatively be coupled to different garments via the wireless power transmission harness. For example, the biometric sensors 222 are coupled to the uniform top 210. The computing device 202 may be coupled to the biometric sensors 222 via the inductive charging pads 226 and 228. As another example, the weapon system 220 comprises an inductive charging pad 236 configured to be inductively coupled to a shoulder-mounted inductive charging pad 238 located at the uniform top 210. Accordingly, the wireless power transmission harness may couple the computing device 202 to the weapon system 220 via the inductive charging pads 226, 228, 236, and 238. In this manner, the wireless power transmission harness enables power to be transferred between different wearable devices.

FIG. 3 shows one example of a charging decision model used to determine how to allocate power between the wearable devices illustrated in FIG. 2. As introduced above, the computing device 202 may be configured to determine a charge state 240 for itself, the radio 218, the weapon system 220, and the biometric sensors 222. In the example of FIG. 3, the weapon system 220 has a charge state of 30%, the radio 218 has a charge state of 100%, the computing device 202 has a charge state of 80%, and the biometric sensors 222 have a charge state of 50%.

In some examples, the computing device 202 may be configured to determine the charge states 240 by communicating with the other devices. For example, the computing device 202 and the weapon system 220 may be coupled via a wireless data coupling (e.g., WiFi, near-field communications (NFC), or a cellular data service). In this manner, the weapon system 220 may be allowed to transmit an indication of its charge state, its identity, or any other suitable information, to the first wearable device.

In other examples, the computing device 202 may be configured to induce, via the wireless power transmission harness 212, a current in another device (e.g., the radio 218 or the biometric sensors 222). In response to the current, the other device may generate a modulated current in the computing device 202 via the wireless power transmission harness 212. The computing device 202 may analyze the modulated current to determine the charge state or identity of the other device, or any other suitable information.

As another example, the computing device 202 may be configured to communicate dynamically with other devices in a network. For example, the computing device may communicate with wearable devices worn by other individuals in a local environment. The local environment may be a geographical area (e.g., an area within a radius of 300 feet from the computing device), a building, a vehicle (e.g., a truck or a bus), or a designated group of individuals (e.g., a platoon of soldiers or a team of underwater welders). The computing device may determine that it is connected to another wearable device in the local environment based on signal strength, proximity, or any other suitable criteria. For example, the computing device may determine that it is connected to another wearable device that has the highest signal strength of all the devices in the local environment. As another example, the computing device may determine that it is connected to another wearable device that is within a threshold distance (e.g., 5 feet) of the computing device. As yet another example, wearable devices may be assigned to individuals using a method such as Dynamic Host Configuration Protocol (DHCP).

The computing device 202 is further configured to determine a target charge state 242 for itself, the radio 218, the weapon system 220, and the biometric sensors 222. In the example of FIG. 3, the weapon system 220 has a target charge state 242 of 60%, the radio 218 has a target charge state of 20%, and the computing device 202 has a target charge state of 80%. As described in more detail below, the biometric sensors 222 may not be assigned a target charge state.

The target charge states 242 may be determined in any suitable manner. For example, the computing device 202 may be configured to implement artificial intelligence or statistical modeling to predict an amount of power consumption for itself, the weapon system 220, the radio 218, and the biometric sensors 222. For example, the weapon system 220 may include a power storage device 254 having a capacity of 10 Wh. The computing device 202 may predict that the weapon system 220 will operate at one watt over the course of a six-hour mission. Accordingly, the power storage device 254 may have a target charge state of at least 6 Wh or 60%. As another example, the computing device 202 may determine that the radio 218 is connected but is not likely to be used on this mission. Accordingly, the radio 218 may have a relatively low target charge state (e.g., 20%).

In yet other examples, the target charge states 242 may be user input. For example, the computing device 202 may be coupled to an input device configured to receive instructions from a user. For example, the instructions may be received via a voice input, a control button, or any other suitable user input mechanism. In some examples, the computing device 202 may be coupled to an output device (e.g., a display device) configured to provide feedback in response to the user input and/or to output other information, such as the charge states 240 or a charge direction (e.g., to inform the user if power is being transferred to or from any of the devices).

In addition, the computing device 202 is configured to determine a power usage priority 244 for itself, the radio 218, the weapon system 220, and the biometric sensors 222. As shown in FIG. 3, the weapon system 220 has a power usage priority 244 of 1, the radio 218 and the computing device 202 each have power usage priorities of 2, and the biometric sensors 222 have a power usage priority of 3.

In some examples, the power usage priorities 244 are determined via data communication as described above. For example, the weapon system 220 may transmit an indication of its power usage priority to the computing device 202. As another example, the weapon system 220, the radio 218, and/or the biometric sensors 222 may include a radio frequency identification (RFID) tag. The computing device 202 may be configured to read a value from the RFID tag. Based on the value, the computing device 202 may be configured to identify the weapon system 220, the radio 218, and/or the biometric sensors 222.

The computing device 202 may assign the power usage priorities 244 to each device based at least in part on the identity of each device. For example, the computing device 202 of FIG. 2 may identify the weapon system 220 and the biometric sensors 222. As the weapon system 220 may be more important to a soldier in combat than the biometric sensors 222, the computing device 202 may assign the weapon system 220 a higher power usage priority (e.g., a ranking of “1”) than the biometric sensors 222 (e.g., a ranking of “3”).

Based on the charge states, the power usage priorities, and the target charge states, power may be transferred between the weapon system 220, the radio 218, the computing device 202, and the biometric sensors 222. For example, the computing device 202 may apply a charging decision model 246 to allocate power between the devices.

The charging decision model 246 may include a policy 248 that is used to determine how to allocate the power. As one example policy, power may not be taken away from any devices having a power usage priority 244 of “1” (e.g., the weapon system 220). Instead, the charging decision model 246 may always seek to charge a priority 1 device if the charge state 240 of the priority 1 device is below its target charge state 242. A priority 2 device may be drained to charge another device when its charge is above its target charge state. When the priority 2 device is below its target charge state, another device that is priority 2 or lower (e.g., priority 3) may be drained to charge that device. A priority 3 device may be drained to charge any other devices that are below their target charge state.

As one example, the radio 218 may comprise a 50 Wh battery that is fully charged (100%). However, as described above, the target charge state of the radio is 20%. Accordingly, the radio 218 may be able to transfer up to 40 Wh to another device. The weapon system 220 has a higher priority than the radio 218 and has a charge state 240 that is below its target charge state 242. As such, the charging decision model 246 may output a charge action 250 to drain the radio 218 and recharge the weapon system 220 until it reaches its target charge state.

As shown in FIG. 3, some devices may have the same priority. For example, the radio 218 and the computing device 202 are both priority “2”. When two or more devices have the same priority, the policy 248 may include charging both devices to an equivalent percentage of the target charge state 242. When one device has a current charge state 240 that is greater than its target charge state 242 (the current charge state is more than 100% of the target charge state), the charging decision model 246 may treat the equivalent percentage as 100%. For example, the radio 218 has a current charge state of 100%, which is greater than its target charge state (20%). Accordingly, the radio 218 may be drained to maintain the computing device 202 at a charge state 240 of 80%.

In some examples, the charging decision model 246 may include user-provided charging instructions 252. For example, one or more wearable devices (e.g., the weapon system 220) may be locked. In a locked state, the one or more wearable devices may receive power from other wearable devices but may not be allowed to transmit power to other wearable devices. In this manner, a relatively important device may be protected from being drained to supply power to a less important device. In other examples, the user-provided charging instructions 252 may comprise instructions to modify the target charge state 242 and/or the power usage priority 244 of any device. The user-provided charging instructions 252 may additionally or alternatively comprise instructions to modify the charging decision model 246 and/or the policy 248, and/or to output a specific charge action 250.

For example, the instructions 252 may comprise an external command to wirelessly transfer power between one or more devices. For example, a company commander may instruct a platoon of soldiers to leave some wearable devices behind before going on a mission, and to consolidate energy from those devices into the power storage device 204 of the computing device 202.

As yet another example, the first wearable device 102 of FIG. 1 may be configured to operate in a heat generation mode. In the heat generation mode, the first wearable device 102 may consume power from any available power sources as quickly as possible to generate heat. For example, the processor 108 may be instructed to calculate the square root of −1. In some examples, the heat generation mode may be initiated based on an instruction received from the remote computing device 126. In other examples, the heat generation mode may be initiated based on data received from the second wearable device 104 and/or the additional wearable device(s) 128. For example, the computing device 202 of FIG. 2 may enter a heat generation mode based on data received from the biometric sensors 222 indicating that a user may be hypothermic.

It will also be appreciated that the charge states, the power usage priorities, and/or the target charge states may be determined dynamically or may change over time. For example, a firefighter working into the night may use the system 100 of FIG. 1 to begin redirecting power from other wearable devices to a flashlight or a headlamp as sunset approaches.

With reference now to FIG. 4, a flowchart is illustrated depicting an example method 400 for managing power between wearable devices. The following description of method 400 is provided with reference to the software and hardware components described above and shown in FIGS. 1-3, and 5. In some examples, the method 400 may be performed at the first wearable device 102 of FIG. 1 or at the computing device 202 of FIG. 2. It will be appreciated that method 400 also may be performed in other contexts using other suitable hardware and software components.

It will be appreciated that the following description of method 400 is provided by way of example and is not meant to be limiting. It will be understood that various steps of method 400 can be omitted or performed in a different order than described, and that the method 400 can include additional and/or alternative steps relative to those illustrated in FIG. 4 without departing from the scope of this disclosure.

At 402, the method 400 includes determining charge states of the first power storage device and a second power storage device coupled to a second wearable device. At 404, the method 400 includes assigning power usage priorities for the first wearable device and the second wearable device. At 406, the method 400 includes determining target charge states for the first power storage device and the second power storage device. At 408, the method 400 includes, based on the charge states, the power usage priorities, and the target charge states, using a wireless power transmission harness that is removably coupled to the first wearable device and the second wearable device to wirelessly transfer power between the first power storage device and the second power storage device.

At 410, the method 400 may include, when the power usage priority for the first wearable device is greater than the power usage priority for the second wearable device, wirelessly transferring power from the second power storage device to the first power storage device. When the power usage priority for the second wearable device is greater than the power usage priority for the first wearable device, the method 400 may include wirelessly transferring power from the first power storage device to the second power storage device.

At 412, the method 400 may include wirelessly transferring the power via an inductive coupling between the wireless power transmission harness and the second wearable device. The method 400 may additionally or alternatively include transmitting electromagnetic radiation from the wireless power transmission harness to the second wearable device. In this manner, power may be easily transferred and managed between a plurality of wearable devices.

In some embodiments, the methods and processes described herein may be tied to a computing system of one or more computing devices. In particular, such methods and processes may be implemented as a computer-application program or service, an application-programming interface (API), a library, and/or other computer-program product.

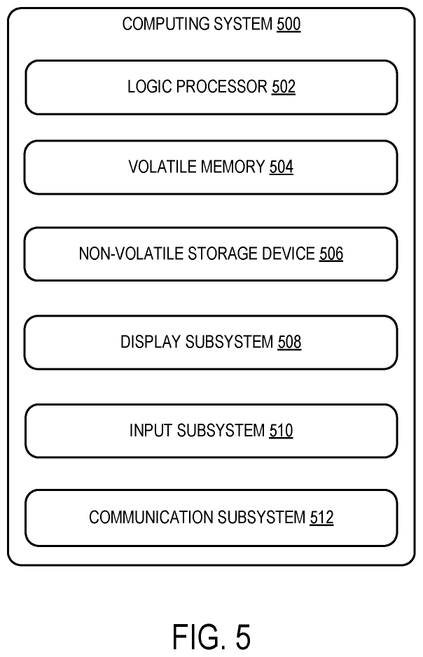

FIG. 5 schematically shows a non-limiting example of a computing system 500 that can enact one or more of the devices and methods described above. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices. In some examples, the computing system 400 may embody the first wearable device 102 or the second wearable device 104 described above and illustrated in FIG. 1, or the computing device 202 described above and illustrated in FIG. 2.

The computing system 500 includes a logic processor 502 volatile memory 504, and a non-volatile storage device 506. The computing system 500 may optionally include a display subsystem 508, input subsystem 510, communication subsystem 512, and/or other components not shown in FIG. 5.

Logic processor 502 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the logic processors to implement the methods and processes described herein. When such methods and processes are implemented, the state of non-volatile storage device 506 may be transformed—e.g., to hold different data.

Non-volatile storage device 506 may include physical devices that are removable and/or built-in. Non-volatile storage device 506 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Aspects of logic processor 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, or game controller. In some examples, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wireless telephone network, or a wired or wireless local- or wide-area network. In some examples, the communication subsystem may allow computing system 500 to send and/or receive messages to and/or from other devices via a network such as the Internet.

The following paragraphs discuss several aspects of the present disclosure. According to one aspect of the present disclosure, a first wearable device is provided. The first wearable device comprises a first power storage device, a processor, and a memory storing instructions executable by the processor. The instructions are executable by the processor to determine charge states of the first power storage device and a second power storage device coupled to a second wearable device, assign power usage priorities for the first wearable device and the second wearable device, determine target charge states for the first power storage device and the second power storage device, and, based on the charge states, the power usage priorities, and the target charge states, use a wireless power transmission harness that is removably coupled to the first wearable device and the second wearable device to wirelessly transfer power between the first power storage device and the second power storage device.

The instructions may additionally or alternatively be executable to, when the power usage priority for the first wearable device is greater than the power usage priority for the second wearable device, wirelessly transfer power from the second power storage device to the first power storage device, and when the power usage priority for the second wearable device is greater than the power usage priority for the first wearable device, wirelessly transfer power from the first power storage device to the second power storage device.

The first wearable device may additionally or alternatively include, wherein the wireless power transmission harness is electrically coupled to the first wearable device via an electrical connector, and the wireless power transmission harness is electrically coupled to the second wearable device via a wireless power transfer device. The first wearable device may additionally or alternatively include, wherein the wireless power transmission harness is magnetically coupled to the second wearable device, thereby aligning the wireless power transfer device in a charging alignment with a second wireless power transfer device that is electrically coupled to the second wearable device. The first wearable device may additionally or alternatively include, wherein the first wearable device and the second wearable device are coupled via a wireless data coupling, and the first wearable device and the second wearable device are further coupled via a wireless power coupling.

The first wearable device may additionally or alternatively include, wherein the wireless power transmission harness is integrated with a garment. The first wearable device may additionally or alternatively include, wherein the first wearable device and the second wearable device are coupled to the garment at different locations. The first wearable device may additionally or alternatively include, wherein the first wearable device is coupled to the garment, and the second wearable device is coupled to a different garment.

The instructions may additionally or alternatively be executable to read a value from a radio frequency identification (RFID) tag, based on the value, identify an identity of the second wearable device, and assign the power usage priorities based at least in part on the identity of the second wearable device. The instructions may additionally or alternatively be executable to induce, via the wireless power transmission harness, a current in the second wearable device, receive, via the wireless power transmission harness, a modulated current generated by the second wearable device, analyze the modulated current, based on analyzing the modulated current, identify an identity of the second wearable device, and assign the power usage priorities based at least in part on the identity of the second wearable device.

The instructions may additionally or alternatively be executable to wirelessly transfer the power via an inductive coupling between the wireless power transmission harness and the second wearable device, or transmit electromagnetic radiation from the wireless power transmission harness to the second wearable device. The instructions may additionally or alternatively be executable to receive an external command to wirelessly transfer the power. The instructions may additionally or alternatively be executable to predict an amount of power consumption for the first wearable device and the second wearable device, and determine the target charge states based at least on the predicted amount of power consumption.

According to another aspect of the present disclosure, a system is provided for managing power between wearable devices. The system comprises a first wearable device comprising, a first power storage device, a processor, and a memory storing instructions executable by the processor. The system further comprises a second wearable device comprising a second power storage device, and a wireless power transmission harness that is removably coupled to the first wearable device and the second wearable device. The instructions are executable by the processor to determine charge states of the first power storage device and the second power storage device, assign power usage priorities for the first wearable device and the second wearable device, determine target charge states for the first power storage device and the second power storage device, and based on the charge states, the power usage priorities, and the target charge states, use the wireless power transmission harness to wirelessly transfer power between the first power storage device and the second power storage device.

The instructions may additionally or alternatively be executable to, when the power usage priority for the first wearable device is greater than the power usage priority for the second wearable device, wirelessly transfer power from the second power storage device to the first power storage device, and when the power usage priority for the second wearable device is greater than the power usage priority for the first wearable device, wirelessly transfer power from the first power storage device to the second power storage device.

The instructions may additionally or alternatively be executable to, wirelessly transfer the power via an inductive coupling between the wireless power transmission harness and the second wearable device, or transmit electromagnetic radiation from the wireless power transmission harness to the second wearable device. The instructions may additionally or alternatively be executable to predict an amount of power consumption for the first wearable device and the second wearable device, and determine the target charge states based at least on the predicted amount of power consumption.

According to another aspect of the present disclosure, a method is provided for managing power between wearable devices. The method comprises, at a first wearable device including a processor and associated memory and a first power storage device coupled thereto, determining charge states of the first power storage device and a second power storage device coupled to a second wearable device, assigning power usage priorities for the first wearable device and the second wearable device, determining target charge states for the first power storage device and the second power storage device, and based on the charge states, the power usage priorities, and the target charge states, using a wireless power transmission harness that is removably coupled to the first wearable device and the second wearable device to wirelessly transfer power between the first power storage device and the second power storage device.

The method may additionally or alternatively include, when the power usage priority for the first wearable device is greater than the power usage priority for the second wearable device, wirelessly transferring power from the second power storage device to the first power storage device, and when the power usage priority for the second wearable device is greater than the power usage priority for the first wearable device, wirelessly transferring power from the first power storage device to the second power storage device. The method may additionally or alternatively include wirelessly transferring the power via an inductive coupling between the wireless power transmission harness and the second wearable device, or transmitting electromagnetic radiation from the wireless power transmission harness to the second wearable device.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described methods may be changed.

The subject matter of the present disclosure includes all novel and non-obvious combinations and sub-combinations of the various methods, systems and configurations, and other features, functions, acts, and/or properties disclosed herein, as well as any and all equivalents thereof.

1. A first wearable device, comprising:
a first power storage device;
a processor; and
a memory storing instructions executable by the processor to,
determine charge states of the first power storage device and a second power storage device coupled to a second wearable device;
assign power usage priorities for the first wearable device and the second wearable device;
determine target charge states for the first power storage device and the second power storage device; and
based on the charge states, the power usage priorities, and the target charge states, use a wireless power transmission harness that is removably coupled to the first wearable device and the second wearable device to wirelessly transfer power between the first power storage device and the second power storage device.

2. The first wearable device of claim 1, wherein the instructions are further executable to:
when the power usage priority for the first wearable device is greater than the power usage priority for the second wearable device, wirelessly transfer power from the second power storage device to the first power storage device; and
when the power usage priority for the second wearable device is greater than the power usage priority for the first wearable device, wirelessly transfer power from the first power storage device to the second power storage device.

3. The first wearable device of claim 1, wherein:
the wireless power transmission harness is electrically coupled to the first wearable device via an electrical connector; and
the wireless power transmission harness is electrically coupled to the second wearable device via a wireless power transfer device.

4. The first wearable device of claim 3, wherein the wireless power transmission harness is magnetically coupled to the second wearable device, thereby aligning the wireless power transfer device in a charging alignment with a second wireless power transfer device that is electrically coupled to the second wearable device.

5. The first wearable device of claim 3, wherein:
the first wearable device and the second wearable device are coupled via a wireless data coupling; and
the first wearable device and the second wearable device are further coupled via a wireless power coupling.

6. The first wearable device of claim 1, wherein the wireless power transmission harness is integrated with a garment.

7. The first wearable device of claim 6, wherein the first wearable device and the second wearable device are coupled to the garment at different locations.

8. The first wearable device of claim 6, wherein the first wearable device is coupled to the garment, and the second wearable device is coupled to a different garment.

9. The first wearable device of claim 1, wherein the instructions are further executable to:
read a value from a radio frequency identification (RFID) tag;
based on the value, identify an identity of the second wearable device; and
assign the power usage priorities based at least in part on the identity of the second wearable device.

10. The first wearable device of claim 1, wherein the instructions are further executable to:
induce, via the wireless power transmission harness, a current in the second wearable device;
receive, via the wireless power transmission harness, a modulated current generated by the second wearable device;
analyze the modulated current;
based on analyzing the modulated current, identify an identity of the second wearable device; and
assign the power usage priorities based at least in part on the identity of the second wearable device.

11. The first wearable device of claim 1, wherein the instructions are further executable to:
wirelessly transfer the power via an inductive coupling between the wireless power transmission harness and the second wearable device; or
transmit electromagnetic radiation from the wireless power transmission harness to the second wearable device.

12. The first wearable device of claim 1, wherein the instructions are further executable to receive an external command to wirelessly transfer the power.

13. The first wearable device of claim 1, wherein the instructions are further executable to:
predict an amount of power consumption for the first wearable device and the second wearable device; and
determine the target charge states based at least on the predicted amount of power consumption.

14. A system for managing power between wearable devices, the system comprising:
a first wearable device comprising,
a first power storage device,
a processor, and
a memory storing instructions executable by the processor;
a second wearable device comprising a second power storage device; and
a wireless power transmission harness that is removably coupled to the first wearable device and the second wearable device;
wherein the instructions are executable by the processor to,
determine charge states of the first power storage device and the second power storage device;
assign power usage priorities for the first wearable device and the second wearable device;
determine target charge states for the first power storage device and the second power storage device; and
based on the charge states, the power usage priorities, and the target charge states, use the wireless power transmission harness to wirelessly transfer power between the first power storage device and the second power storage device.

15. The system of claim 14, wherein the instructions are further executable to:
when the power usage priority for the first wearable device is greater than the power usage priority for the second wearable device, wirelessly transfer power from the second power storage device to the first power storage device; and
when the power usage priority for the second wearable device is greater than the power usage priority for the first wearable device, wirelessly transfer power from the first power storage device to the second power storage device.

16. The system of claim 14, wherein the instructions are further executable to:
wirelessly transfer the power via an inductive coupling between the wireless power transmission harness and the second wearable device; or
transmit electromagnetic radiation from the wireless power transmission harness to the second wearable device.

17. The system of claim 14, wherein the instructions are further executable to:
predict an amount of power consumption for the first wearable device and the second wearable device; and
determine the target charge states based at least on the predicted amount of power consumption.

18. A method for managing power between wearable devices, the method comprising:
at a first wearable device including a processor and associated memory and a first power storage device coupled thereto,
determining charge states of the first power storage device and a second power storage device coupled to a second wearable device;
assigning power usage priorities for the first wearable device and the second wearable device;
determining target charge states for the first power storage device and the second power storage device; and
based on the charge states, the power usage priorities, and the target charge states, using a wireless power transmission harness that is removably coupled to the first wearable device and the second wearable device to wirelessly transfer power between the first power storage device and the second power storage device.

19. The method of claim 18, further comprising:
when the power usage priority for the first wearable device is greater than the power usage priority for the second wearable device, wirelessly transferring power from the second power storage device to the first power storage device; and
when the power usage priority for the second wearable device is greater than the power usage priority for the first wearable device, wirelessly transferring power from the first power storage device to the second power storage device.

20. The method of claim 18, further comprising:
wirelessly transferring the power via an inductive coupling between the wireless power transmission harness and the second wearable device; or
transmitting electromagnetic radiation from the wireless power transmission harness to the second wearable device.
